(19) United States
(12) Patent Application Publication
(10) Pub. No.: US 2026/0041022 A1
(43) Pub. Date: Feb. 12, 2026

(54) AUTOMATIC GUIDANCE OF AGRICULTURAL VEHICLES BASED ON FEEDBACK AND FEEDFORWARD CONTROL LOOPS

(71) Applicant: CNH INDUSTRIAL AMERICA LLC, New Holland, PA (US)

(72) Inventors: Abhinav Tripathi, New Holland, PA (US); Heather Paxinos, New Holland, PA (US); Aditya Singh, Bolingbrook, IL (US)

(73) Assignee: CNH INDUSTRIAL AMERICA LLC, New Holland, PA (US)

(21) Appl. No.: 18/796,092

(22) Filed: Aug. 6, 2024

(51) Int. Cl. A01B 69/04

(52) U.S. Cl. CPC A01B 69/008

(57) ABSTRACT

An agricultural vehicle can include one or more sensors, a first controller, and a second controller. The first controller can receive first data from the one or more sensors, determine a difference between a heading of the agricultural vehicle and a path to take along the crop row, generate a prediction of an adjustment to the heading of the agricultural vehicle to align the agricultural vehicle with the path to take along the crop row, transmit one or more signals to control the agricultural vehicle to cause the agricultural vehicle to align with the path, and store second data to indicate a plurality of paths taken by the agricultural vehicle along the crop row. The second controller can generate a second path for the agricultural vehicle to take along the crop row at one or more subsequent points in time.

### BACKGROUND

The present disclosure relates generally to the control of agricultural vehicles. More specifically, the present disclosure relates to automatic guidance of agricultural vehicles.

### SUMMARY

At least one embodiment relates to an agricultural vehicle. The agricultural vehicle can include one or more sensors. The one or more sensors can be disposed on the agricultural vehicle. The one or more sensors can collect data associated with the agricultural vehicle. The agricultural vehicle can include a first controller. The first controller can include one or more first memory devices. The one or more first memory can store first instructions. The first instructions can, when executed by one or more first processors, cause the one or more first processors to receive, from the one or more sensors, first data to indicate a speed of the agricultural vehicle, an orientation of a tractive element of the agricultural vehicle, and a position of a crop row relative to the agricultural vehicle. The first instructions can cause the one or more first processors to determine, based on the first data using a nonlinear model, a difference between a heading of the agricultural vehicle and a path to take along the crop row. The first instructions can cause the one or more first processors to generate, responsive to determination of the difference, a prediction of an adjustment to the heading of the agricultural vehicle to align the agricultural vehicle with the path to take along the crop row. The first instructions can cause the one or more first processors to transmit, responsive to generation of the prediction, one or more signals to control the agricultural vehicle to cause the agricultural vehicle to align with the path. The first instructions can cause the one or more first processors to store, responsive to monitoring movement of the agricultural vehicle, in a database, second data to indicate a plurality of paths taken by the agricultural vehicle along the crop row. The agricultural vehicle can include a second controller. The second controller can include one or more second memory devices. The one or more second memory devices can store second instructions. The second instructions can, when executed by one or more second processors, cause the one or more second processors to retrieve, from the database, at least a portion of the second data. The second instructions can cause the one or more second processors to generate, based on the at least a portion of the second data, a second path for the agricultural vehicle to take along the crop row at one or more subsequent points in time.

At least one embodiment relates to an agricultural vehicle. The agricultural vehicle can include a controller. The controller can include one or more memory devices. The one or more memory devices can store instructions. The instructions can, when executed by one or more processors, cause the one or more processors to receive, from one or more sensors, first data to indicate a speed of the agricultural vehicle, an orientation of a tractive element of the agricultural vehicle, and a position of a crop row relative to the agricultural vehicle. The instructions can cause the one or more processors to determine, based on the first data using a nonlinear model, a difference between a heading of the agricultural vehicle and a path to take along the crop row. The instructions can cause the one or more processors to generate, responsive to determination of the difference, a prediction of an adjustment to the heading of the agricultural vehicle to align the agricultural vehicle with the path to take along the crop row. The instructions can cause the one or more processors to transmit, responsive to generation of the prediction, one or more signals to control the agricultural vehicle to cause the agricultural vehicle to align with the path. The instructions can cause the one or more processors to store, responsive to monitoring movement of the agricultural vehicle, in a database, second data to indicate a plurality of paths taken by the agricultural vehicle along the crop row. The controller can implement a feedback loop based on the first data.

At least one embodiment relates to a control system for an agricultural vehicle. The control system can include a first controller. The first controller can include one or more memory devices. The one or more memory devices can store instructions. The instructions can, when executed by one or more processors, cause the one or more processors to receive, from one or more sensors, first data to indicate a speed of the agricultural vehicle, an orientation of a tractive element of the agricultural vehicle, and a position of a crop row relative to the agricultural vehicle. The instructions can cause the one or more processors to determine, based on the first data using a nonlinear model, a difference between a heading of the agricultural vehicle and a path to take along the crop row. The instructions can cause the one or more processors to generate, responsive to determination of the difference, a prediction of an adjustment to the heading of the agricultural vehicle to align the agricultural vehicle with the path to take along the crop row. The instructions can cause the one or more processors to transmit, responsive to generation of the prediction, one or more signals to control the agricultural vehicle to cause the agricultural vehicle to align with the path. The instructions can cause the one or more processors to store, responsive to monitoring movement of the agricultural vehicle, in a database, second data to indicate a plurality of paths taken by the agricultural vehicle along the crop row. The control system can include a second controller. The second controller can implement a feedforward loop based on at least a portion of the second data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle illustrated in FIG. 1, according to an exemplary embodiment.

FIG. 3 is a schematic block diagram of a driveline of the vehicle illustrated in FIG. 1, according to an exemplary embodiment.

FIG. 4 is a block diagram of a system that includes the vehicle illustrated in FIG. 1, according to an exemplary embodiment.

FIG. 5 is a block diagram of a control loop including a feedback loop and a feedforward loop, according to an exemplary embodiment.

FIG. 6 is an aerial view of an environment including the vehicle illustrated in FIG. 1 and a crop row, according to an exemplary embodiment.

FIG. 7 is an example user interface including information associated with the vehicle illustrated in FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure describes systems and methods for automatic guidance of agricultural vehicles based on feedback and feedforward control loops. For example, a nonlinear observer can receive information associated with an agricultural vehicle (e.g., crop row sensor information, vehicle speed, and current wheel angle information). To continue this example, the nonlinear observer can generate a prediction of a cross track error and/or a heading error of the agricultural vehicle relative to the crop row. A feedback controller can use the cross track error and/or the heading error to control, move, and/or adjust the agricultural vehicle to guide the agricultural vehicle to a predetermined point of the crop row. A feedforward controller can use previous operational information (e.g., previous control routines, previous vehicle travel patterns, etc.) to predict a curvature pattern of the crop row. The feedforward controller can use previous patterns to detect changes in the curvature pattern of the crop row.

The nonlinear observer, the feedback controller, and the feedforward controller can work in tandem with one another by providing various types of information as inputs into the control loops. For example, the nonlinear observer can receive, as inputs, one or more outputs of the feedforward controller. As another example, the feedback controller can receive, as inputs, one or more outputs of the nonlinear observer.

Automatic guidance and/or control of an agricultural vehicle (e.g., combine, tractor, sprayer, etc.) may involve guiding the agricultural vehicle in a farm and/or field with crops arranged in curved rows. The curvature (e.g., the curved rows) can slowly change over a wide range of area thus making it difficult to keep the agricultural vehicle centered and/or aligned with a given crop row. The varying curvature of the crop rows can lead to inefficient harvesting as the agricultural vehicle may struggle to respond to changes in the curvature which causes the agricultural vehicle to be offset relative to the crop row. Inefficient harvesting can be speed dependent (e.g., a speed of the agricultural vehicle) and as such the inefficient harvesting can increase as speed of the agricultural vehicle increases.

Other control systems for agricultural vehicles can implement PID controllers that are tuned to very specific sensor outputs to achieve acceptable performance of the agricultural vehicle. The tunning of the PID controllers can be based on various predetermined speeds and/or curvatures. However, these tunning techniques do not account for changes and/or variances in speed and/or curvature of the crop rows.

Some of the technical solutions described herein include a control system that includes a nonlinear observer, a feedback controller, and a feedforward controller. The nonlinear observer can user crop sensor information, vehicle speed, and wheel angle information to detect deviations (e.g., cross track error, heading error, etc.) in an alignment of the agricultural vehicle relative to a crop row. The feedback controller can use the deviations to control subsequent movement of the agricultural vehicle to align the agricultural vehicle with the crop row. The feedforward controller can use previous drive path information to generate predictions of future crop row curvatures.

### Overall Vehicle

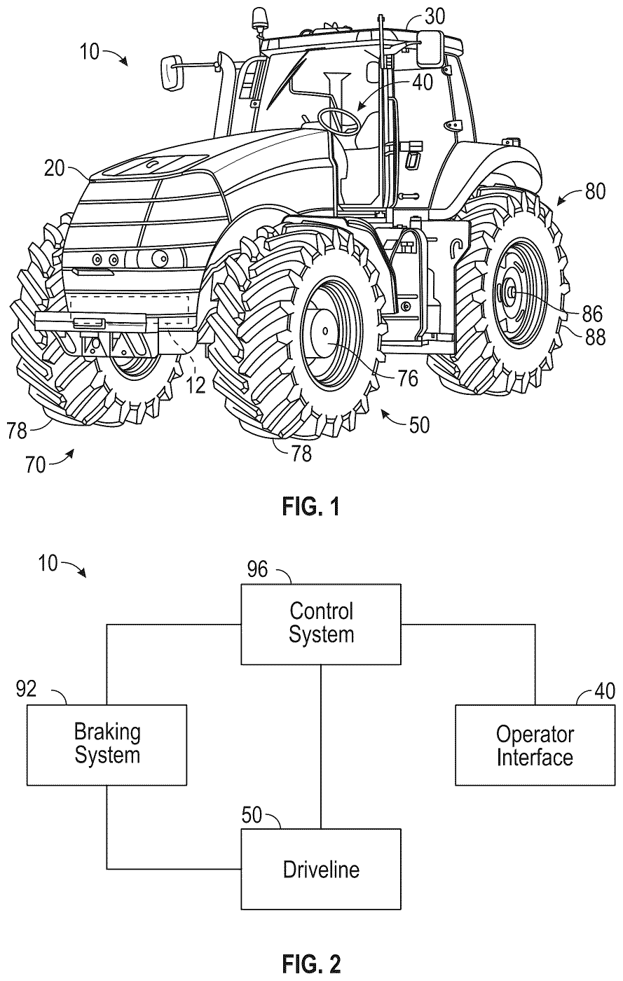

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 92, coupled to one or more components of the driveline 50 to facilitate selectively braking the one or more components of the driveline 50; and a vehicle control system, shown as control system 96, coupled to the operator interface 40, the driveline 50, and the braking system 92. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 52) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc. In some embodiments, the operator interface 40 may include at least one of a screen, a monitor, a visual display device, a touchscreen display, a television, a video display, a light emitting diode (LED) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the operator interface may include displays that include a resistive touchscreen that can receive user input via interactions (e.g., touches) with the touchscreen.

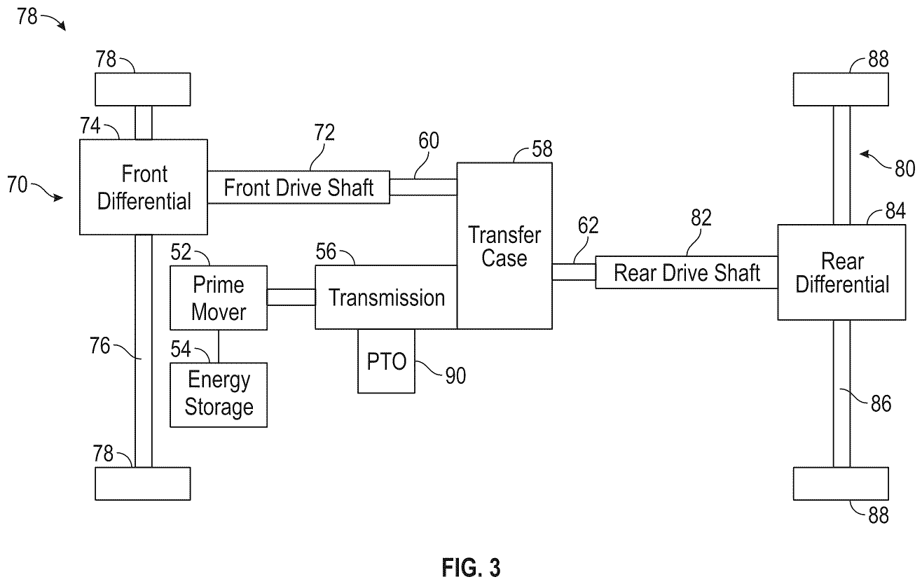

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 92 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 92 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

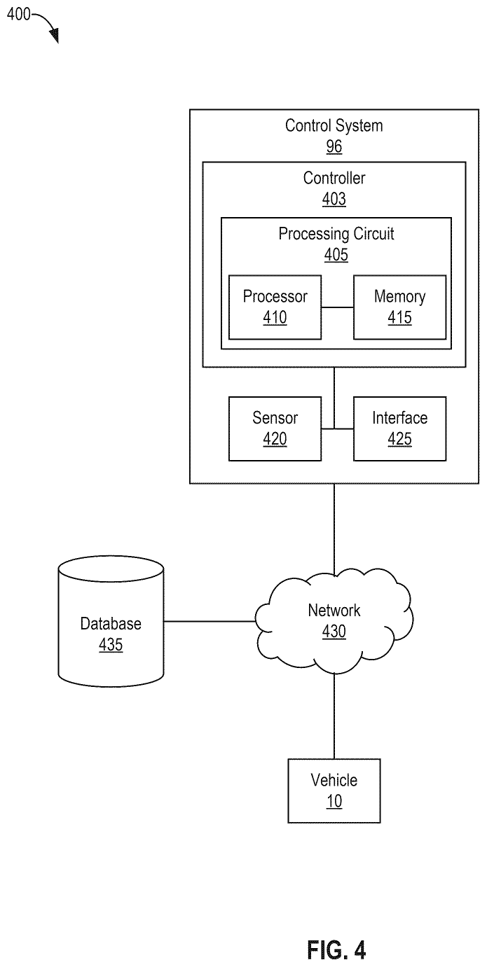

FIG. 4 depicts a block diagram of a system 400, according to an exemplary embodiment. In some embodiments, the system 400 and/or one or more components thereof may implement and/or include a closed-loop system. Each system and/or component of the system 400 can include one or more processors, memory, network interfaces, communication interfaces, and/or user interfaces. Memory can store programming logic that, when executed by the processors, controls the operation of the corresponding computing system or device. Memory can also store data in databases. The network interfaces can allow the systems and/or components of the system 400 to communicate wirelessly. The communication interfaces can include wired and/or wireless communication interfaces and the systems and/or components of the system 400 can be connected via the communication interfaces. The various components in the system 400 can be implemented via hardware (e.g., circuitry), software (e.g., executable code), or any combination thereof. Systems, devices, and components in FIG. 4 can be added, deleted, integrated, separated, and/or rearranged.

In some embodiments, the system 400 may include the control system 96, the vehicle 10, a network 430, and/or a database 435. In some embodiments, the system 400 and/or one or more systems, devices, and/or components thereof may implement at least one of the various techniques described herein. For example, the control system 96 may provide automatic guidance of the vehicle 10. As another example, the control system 96 may implement at least one of the nonlinear observer, the feedback controller, and/or the feedforward controller described herein. While the control system 96, as shown in FIG. 4, is separate from the vehicle 10, the control system 96 may be integrated with and/or included with the vehicle 10.

In some embodiments, the network 430 may include at least one of a local area network (LAN), wide area network (WAN), telephone network (such as the Public Switched Telephone Network (PSTN)), Controller Area Network (CAN), wireless link, intranet, the Internet, a cellular network, and/or combinations thereof. In some embodiments, the various systems, components, and/or devices included in the system 400 may communicate with one another via the network 430.

In some embodiments, the database 435 may include at least one of a computing device, a remote server, a server bank, a remote device, and/or among other possible computer hardware and/or computer software. For example, the database 435 may include a server bank and the server bank can store, keep, maintain, and/or otherwise hold the various types of information described herein. In some embodiments, the database 435 may house and/or otherwise implement at least one of the various systems, devices, and/or components described herein. In some embodiments, the database 435 may include, store, maintain, and/or otherwise host the control system 96. For example, the control system 96 may be distributed across one or more servers (e.g., the database 435). In some implementations, the control system 96 and/or various other components of the system 400 may be implemented using cloud computing services/platforms.

In some embodiments, the control system 96 may include at least one controller 403, at least one sensor 420, and/or at least one interface 425. The various components of the control system 96 (e.g., the controller 403, the sensors 420, and the interface 425) may be communicably coupled with one another. In some embodiments, the control system 96 may control, operate, and/or maneuver the vehicle 10. For example, the control system 96 may control the prime mover to drive the tractive elements 78 and 88. As another example, the control system 96 can operate the steering wheel of the vehicle 10. Stated otherwise, the control system 96 may implement automatic guidance of the vehicle 10 by controlling various operations and/or components of the vehicle 10.

In some embodiments, the sensors 420 may include at least one of a position sensor, an accelerometer, a tachometer, a speedometer, a GPS device/sensor, a temperature sensor, a voltmeter, an ammeter, a radar sensor, a pressure sensor, a tactile sensor, a photodetector, a motion sensor, a proximity sensor, a telemetry device, and/or among other possible sensors and/or devices. For example, the sensors 420 can include a position sensor that can collect data to determine a position and/or an orientation of the vehicle 10. In other embodiments, the sensors 420 may include cameras, video devices, audio devices, haptic devices, optical devices, and/or other possible optical instruments can capture, record, produce and/or otherwise provide videos and/or images. The cameras can also include audio devices. For example, the cameras can include at least one of a speaker, a microphone, a headphone, and/or among other possible audio and/or sound devices.

In some embodiments, the sensors 420 may be placed, located, situated, positioned, coupled and/or otherwise disposed on various components and/or locations on the vehicle 10. For example, a first sensor 420 may be disposed on the front differential 74 and a second sensor 420 may be disposed on the rear differential. To continue this example, the first sensor 420 may collect information (e.g., telemetry data, vehicle information, vehicle status information) to determine an orientation and/or a placement of the tractive elements 78. As another example, the sensors 420 may collect information to determine a speed and/or acceleration of the vehicle 10. In some embodiments, the sensors 420 may collect the various types of data and/or information described herein. For example, the sensors 420 may collect telemetry data, diagnostics data, vehicle operation data, and/or data inputs. In some embodiments, the telemetry data may include data relating to the operation of the vehicle 10 such as, system statuses, a status of various vehicle subsystems and components (e.g., engine, transmission, tire pressure, brakes, pump(s), etc.), vehicle status (e.g., if a door is open, if equipment is deployed, etc.), and/or implement actions.

In some embodiments, the interface 425 may include at least one of network communication devices, network interfaces, and/or other possible communication interfaces. The interface 425 may include wired or wireless communications interfaces (e.g., jacks, antennas, transmitters, receivers, transceivers, wire terminals, etc.) for conducting data communications with various systems, devices, and/or components described herein. The interface 425 may be direct (e.g., local wired or wireless communications) and/or via a communications network (e.g., the network 430). For example, the interface 425 may include an Ethernet card and port for sending and receiving data via an Ethernet-based communications link or network. The interface 425 may also include a Wi-Fi transceiver for communicating via a wireless communications network (e.g., the network 430). The interface 425 may include a power line communications interface. The interface 425 may include an Ethernet interface, a USB interface, a serial communications interface, and/or a parallel communications interface.

In some embodiments, the controller 403 may include at least one processing circuit 405. For example, the controller 403 may include a first processing circuit 405 and a second processing circuit 405. The processing circuits 405 may include at least one processor 410 and memory 415. In some embodiments, the processing circuits 405 and/or one or more components thereof (e.g., the processors 410 and memory 415) may perform similar functionality to that of the control system 96 and/or one or more components thereof. For example, memory 415 may store programming logic that, when executed by the processors 410, cause the processors 410 to perform automatic guidance of the vehicle 10. In some embodiments, the processing circuits 405 may be communicably connected to one or more components of the control system 96. For example, the processing circuits 405 may be communicably connected to the interface 425. In some embodiments, the processors 410 may be implemented as a general-purpose processor, an application specific integrated circuit (ASIC), one or more field programmable gate arrays (FPGAs), a group of processing components, or other suitable electronic processing components.

In some embodiments, memory 415 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 415 may be or include volatile memory or non-volatile memory. Memory 415 may include database components, object code components, script components, or any other type of information structure for supporting the various activities and information structures described in the present application. According to an exemplary embodiment, memory 415 is communicably connected to the processors 410 via the processing circuits 405 and memory 415 includes computer code for executing (e.g., by the processing circuits 405 and/or the processors 410) one or more processes described herein.

In some embodiments, the vehicle 10 may include the controller 403. For example, the controller 403 may be disposed on the vehicle 10. In some embodiments, the controller 403 may include a first controller 403 and a second controller 403. In other embodiments, memory 415 may store one or more first instructions that cause the processors 410 to perform operations similar to the first controller 403 and one or more second instructions that cause the processors 410 to perform operations similar to the second controller 403.

In some embodiments, the controller 403 can implement a feedback control loop. For example, the first controller 403 can implement a feedback control loop. To continue this example, the first controller 403 can receive various inputs from one or more components and/or devices of the system 400 that serve as feedback to the first controller 403. In this example, the first controller 403 can receive vehicle information (e.g., crop row information, vehicle speed, wheel alignment, etc.) from the sensors 420.

In some embodiments, the controller 403 can implement a feedforward control loop. For example, the second controller 403 can implement a feedforward control loop. To continue this example, the second controller 403 can generate, based on previous paths taken by the vehicle 10 along crop rows, predictions of changes to the curvature of the crop row. In this example, the second controller 403 can provide, as inputs, the predictions of the changes to the first controller 403.

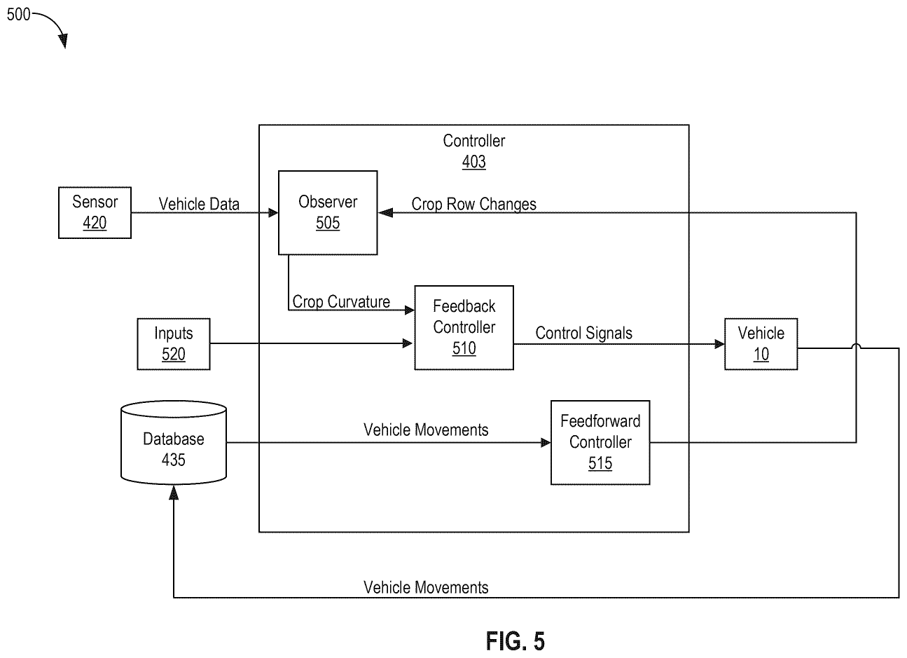

FIG. 5 depicts a block diagram of a control loop 500, according to an exemplary embodiment. In some embodiments, the controller 403 may implement one or more portions, aspects, and/or segments of the control loop 500. For example, the controller 403 may implement a feedback loop of the control loop 500. As another example, the controller 403 may implement a feedforward loop of the control loop 500. In some embodiments, the controller 403 may include at least one observer 505, at least one feedback controller 510, and at least one feedforward controller 515. For example, the first controller 403 can include the feedback controller 510. As another example, the second controller 403 can include the feedforward controller 515. While the observer 505, the feedback controller 510, and the feedforward controller 515, as shown in FIG. 5, are shown as separate components, in some embodiments, the controller 403 may implement the observer 505, the feedback controller 510, and the feedforward controller 515.

In some embodiments, the observer 505, the feedback controller 510, and the feedforward controller 515 may include similar components, circuitry, hardware, software, and/or firmware to various devices described herein. For example, the observer 505 may include the processing circuits 405. In some embodiments, the observer 505, the feedback controller 510, and the feedforward controller 515 may be in communication with one or more systems, devices, and/or components of the vehicle 10. For example, the observer 505 may be in communication with the sensors 420.

In some embodiments, at least one or more components of the controller 403 may be combined, integrated, and/or otherwise merged into a single component. For example, the observer 505 and the feedback controller 510 may be combined. As another example, at least one first component of the controller 403 may perform operations similar to that of at least one second component of the controller 403. For example, the feedback controller 510 may perform operations similar to the of the observer 505.

In some embodiments, the sensors 420 can collect, measure, obtain, and/or otherwise obtain data associated with the vehicle 10. For example, the sensors 420 may be coupled with and/or otherwise attached to the tractive elements 78. To continue this example, the sensors 420 can collect data to indicate a position, an orientation, and/or a placement of the tractive elements (e.g., straight, angled, rotated, tilted, etc.). As another example, the sensors 420 may collect data to indicate a speed of the vehicle 10. As even another example, the sensors 420 may include position sensors. To continue this example, the sensors 420 can collect data to indicate a position of a crop row relative to the vehicle 10. Stated otherwise, the sensors 420 can collect data to indicate a placement and/or a position of the vehicle 10 in space.

In some embodiments, the observer 505 may receive various types of information. For example, as shown in FIG. 5, the observer 505 may receive Vehicle Data from the sensors 420. In some embodiments, the Vehicle Data may include at least one of the various types of information described herein. For example, the Vehicle Data may include a speed of the vehicle 10, an orientation of the vehicle 10 (e.g., wheel alignment, tractive element orientation, component positioning, etc.), and/or a position of crop rows relative to the vehicle 10.

In some embodiments, the observer 505 may implement and/or execute at least one model. For example, the observer 505 may implement a nonlinear model. To continue this example, the observer 505 may use the Vehicle Data as inputs and/or parameters for the nonlinear model. In some embodiments, the observer 505 may determine, using the nonlinear model, one or more differences. For example, the observer 505 may determine a difference between a heading of the vehicle 10 and a path to take along the crop row. Stated otherwise, the observer 505 may determine a curvature of the crop row. As shown in FIG. 5, the observer 505 may provide one or more inputs (shown as Crop Curvature in FIG. 5) to the feedback controller 510. In some embodiments, the Crop Curvature may include information such a deviation between a position of the vehicle 10 relative to a crop row, the difference between the heading of the vehicle 10 and the crop row. In other embodiments, the Crop Curvature may include the Vehicle Data and the feedback controller 510 may determine, based on the Crop Curvature, the difference between the heading of the vehicle 10 and the path to take along the crop row.

In some embodiments, the feedback controller 510 may generate one or more predictions. For example, the feedback controller 510 may generate a prediction of an adjustment to the heading of the vehicle 10. Stated otherwise, the feedback controller 510 may generate a prediction of how to align, arrange, position, and/or place the vehicle 10 relative to the crop row to align the vehicle 10 with the crop row based on the curvature of the crop row. In some embodiments, the feedback controller 510 may generate predictions that pertain to control actions of the vehicle 10. For example, the feedback controller 510 may generate a first prediction that pertains to a first control action. To continue this example, the first prediction may be a prediction of a change in position of the vehicle 10 relative to the crop row that would result from implementation of the first control action. As another example, the feedback controller 510 may generate a second prediction that pertains to the curvature of the crop row. To continue this example, the second prediction may be a prediction that indicates an angle and/or value for the curvature of the crop row.

In some embodiments, the feedback controller 510 may transmit one or more signals. For example, as shown in FIG. 5, the feedback controller 510 may transmit Control Signals to the vehicle 10. In some embodiments, the Control Signals may control the vehicle 10. For example, the Control Signals may cause the prime mover 52 to drive the tractive elements 78. As another example, the Control Signals may cause the tractive elements 78 to rotate and/or swivel.

In some embodiments, the feedback controller 510 may store various types of information. For example, the feedback controller 510 may store information associated vehicle operations associated with the vehicle 10 in the database 435. To continue this example, the information associated with vehicle operations may include at least one of previous paths taken by the vehicle 10, pervious maneuvers performed by the vehicle 10, previous operator inputs received by the control system 96, and/or actions performed by the vehicle 10. In some embodiments, the feedback controller 510 may communicate with the feedforward controller 515 responsive to the feedback controller 510 storing information in the database 435.

In some embodiments, the feedforward controller 515 may retrieve various types of information. For example, the feedforward controller 515 may retrieve information from the database 435. In some embodiments, the feedforward controller 515 may retrieve, from the database 435, information that pertains to the vehicle 10. For example, as shown in FIG. 5, the feedforward controller 515 may retrieve Vehicle Movements from the database 435. In some embodiments, the Vehicle Movements may include at least one of the various types of information described herein. For example, the Vehicle Movements may include previous paths taken by the vehicle 10. As another example, the Vehicle Movements may include previous operations performed by the vehicle 10.

In some embodiments, the feedforward controller 515 may generate one or more paths. For example, the feedforward controller 515 may generate a path for the vehicle 10. To continue this example, the feedforward controller 515 may generate the path based on the Vehicle Movements. In some embodiments, the feedforward controller 515 may generate paths for the vehicle 10 based on pervious paths taken by the vehicle 10. For example, the feedforward controller 515 may predict, based on the previous paths, a change to a curvature of the crop row. To continue this example, the feedforward controller 515 may generate a path for the vehicle 10 to take along the crop row based on the change to the curvature of the crop row. In some embodiments, the feedforward controller 515 may provide one or more outputs (shown as Crop Row Changes in FIG. 5). For example, the feedforward controller 515 may provide an output to indicate the change to the curvature of the crop row. To continue this example, the feedforward controller 515 may provide the output as an input to a subsequent component.

In some embodiments, the feedback controller 510 may receive one or more inputs (shown as inputs 520 in FIG. 5). For example, the feedback controller 510 may receive information from the sensors 420. In some embodiments, the feedback controller 510 may receive the inputs 520 responsive to movement of the vehicle 10. For example, the feedback controller 510 may receive the inputs 520 responsive to the vehicle 10 traveling along a path. In some embodiments, the inputs 520 may include the Crop Row Changes. For example, the inputs 520 may indicate changes to the curvature of the crop row.

In some embodiments, the feedforward controller 515 may transmit one or more signals to control the vehicle 10. For example, the feedforward controller 515 may transmit signals to control the vehicle 10 to cause the vehicle 10 to move in accordance with the change to the curvature of the crop row. Stated otherwise, the feedback controller 510 may control movement of the vehicle 10 to realign the vehicle 10 with the crop row based on the change to the curvature of the crop row.

In some embodiments, the feedback controller 510 may update one or more paths. For example, the feedback controller 510 may update a path for the vehicle 10. As another example, the feedback controller 510 may update a path generated by the feedforward controller 515. In some embodiments, the feedback controller 510 may update the paths based on the inputs 520. For example, the inputs 520 may include an orientation of the vehicle 10 and a path generated by the feedforward controller 515. To continue this example, the feedback controller 510 may update the path based on the orientation of the vehicle 10 indicating that the vehicle 10 has deviated from the path. As another example, the inputs 520 may include the change to the curvature of the crop row. To continue this example, the feedback controller 510 may update the path to adjust movement of the vehicle 10 to account for the change to the curvature of the crop row.

In some embodiments, the feedback controller 510 may detect at least one deviation. For example, the feedback controller 510 may detect a deviation from a path. In this example, the feedback controller 510 may detect the deviation based on a position and/or placement of the vehicle 10 relative to the crop row. As another example, the feedback controller 510 may detect the deviation based on a change to the curvature of the crop row. As even another example, the feedback controller 510 may detect the deviation based on a path currently taken by the vehicle 10 being different than at least one path previous taken by the vehicle 10. In some embodiments, the feedback controller 510 may transmit one or more signals to control subsequent movement of the vehicle 10. For example, the feedback controller 510 may transmit signals to control movement of the tractive elements 78 to realign the vehicle 10 with the crop row.

In some embodiments, the feedback controller 510 may monitor movement of the vehicle 10. For example, the feedback controller 510 may monitor operations of various components of the vehicle 10. As another example, the feedback controller 510 may monitor changes in position and/or placement of the vehicle 10 relative to the crop row. In some embodiments, the feedback controller 510 may determine, responsive to monitoring the movement of the vehicle 10, one or more paths taken by the vehicle 10. For example, the feedback controller 510 may monitor changes in position of the vehicle 10. To continue this example, the feedback controller may determine a given path taken by the vehicle 10 based on the changes in position of the vehicle 10.

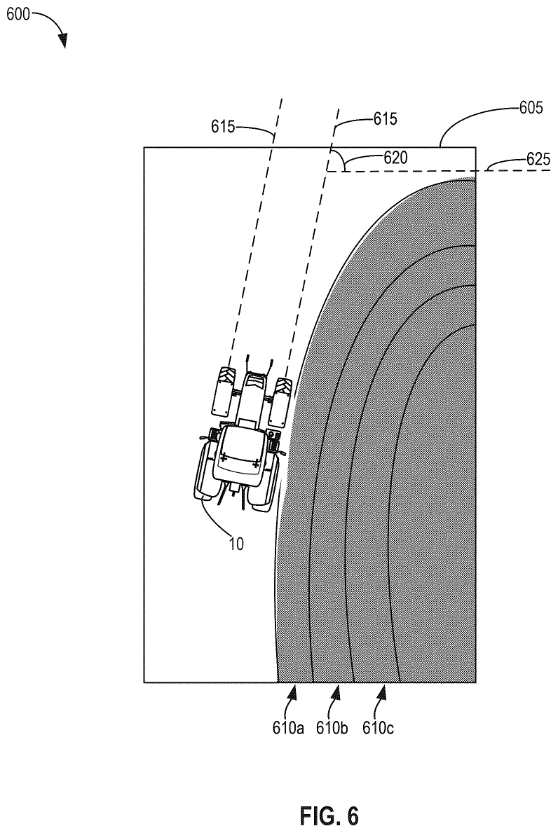

FIG. 6 depicts an aerial view of an environment 600, according to an exemplary embodiment. In some embodiments, the environment 600 may refer to and/or include land, crops, a farm, and/or harvest fields. As shown in FIG. 6, the environment 600 can include the vehicle 10 and a swath 605. In some embodiments, the swath 605 may refer to and/or include crops, crop rows, fields, harvests, and/or other residue arranged in rows. In some embodiments, the vehicle 10 may be positioned and/or located relative to the swath 605. For example, as shown in FIG. 6, the vehicle 10 is positioned within the swath 605. As another example, as shown in FIG. 6, the vehicle 10 can have a heading 615 and/or a direction 615 relative to at least one crop row 610.

In some embodiments, the orientation and/or the placement of the vehicle 10 can be determined based on an angle 620. As shown in FIG. 6, the angle 620 may be an angle between the heading 615 and an axis 625. In some embodiments, the axis 625 may run at least partially perpendicular to the crop rows 610. In other embodiments, the axis 625 may run at least partially parallel to the crop rows 610. In some embodiments, the sensors 420 can collect information to indicate the placement of the vehicle 10 relative to the crop rows 610. For example, the sensors 420 can collect information that indicates an alignment of the tractive elements 78 relative to at least one crop row 610. As another example, the sensors 420 can collect image data that includes a captured view of the vehicle 10 and the crop rows 610. To continue this example, the controller 403 may implement and/or use machine vision to determine a placement of the vehicle 10 relative to the crop rows 610. As another example, the controller 403 can detect portions of the swath 605 that have been harvested and portions of the swath 605 that have not yet been harvested. To continue this example, the controller 403 can determine and/or detect a curvature of the crop rows 610 by monitoring changes to the angle 620 as the vehicle 10 travels along the swath 605.

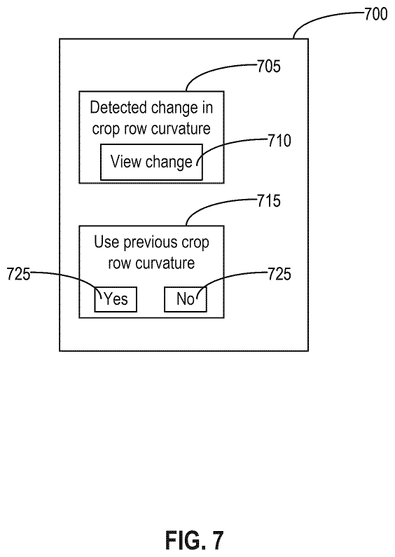

FIG. 7 depicts a user interface 700, according to an exemplary embodiment. In some embodiments, at least one of the various systems, devices, and/or components described herein can produce, generate, provide, and/or otherwise display the user interface 700. For example, the operator interface 40 may display the user interface 700. As another example, the controller 403 may transmit signals to a user device (e.g., a mobile device, a tablet, a monitor, a screen, a display device, a desktop, and/or various other devices capable of display a user interface) to cause the user device to display the user interface 700.

In some embodiments, the user interface 700 may display and/or include at least one type of information described herein. For example, the user interface 700 may include at least one visual indication of the curvature of the crop rows 610. As another example, the user interface 700 may display a rendering of the environment 600. In some embodiments, the controller 403 may cause the user interface 700 to display at least one prompt. For example, as shown in FIG. 7, the user interface 700 includes a prompt 705. To continue this example, the prompt 705 is shown to include a message to indicate that a change in the curvature of the crop row was detected. In some embodiments, an operator of the vehicle 10 may select, interact with, and/or otherwise interface with element 710. For example, as shown in FIG. 7, an operator of the vehicle 10 may select the element 710 to view the change to the curvature of the crop row.

In some embodiments, the controller 403 may provide at least one indication via one or more prompts. For example, the controller 403 may provide, via the prompt 705, an indication of a prediction of a change to the curvature of the crop row. To continue this example, the controller 403 may cause the user interface 700 and/or the prompt 705 to be displayed responsive to generating a prediction of a change to the curvature of the crop row 610.

In some embodiments, the controller 403 may receive one or more indications. For example, as shown in FIG. 7, the user interface 700 includes element 715. To continue this example, the controller 403 may receive at least one indication responsive to a selection of element 725 and/or element 725. In some embodiments, the controller 403 may receive at least one indication via at least one input from the user interface 700 to control movement of the vehicle 10. For example, the controller 403 may receive, via a selection (e.g., an input) of the element 725, an indication to control movement of the vehicle 10 based on a previous crop row curvature (e.g., a crop row curvature prior to the detected change indicated by the prompt 705). To continue this example, the controller 403 may control the vehicle 10 to guide the vehicle 10 along the crop rows 610 in accordance with the previous crop row curvature.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof (e.g., the driveline 50, the braking system 92, the control system 96, etc.) as shown in the various exemplary embodiments is illustrative only. Additionally, any element disclosed in one embodiment may be incorporated or utilized with any other embodiment disclosed herein.

What is claimed is:

1. An agricultural vehicle, comprising:
one or more sensors disposed on the agricultural vehicle, the one or more sensors configured to collect data associated with the agricultural vehicle;
a first controller comprising one or more first memory devices storing first instructions thereon that, when executed by one or more first processors, cause the one or more first processors to:
receive, from the one or more sensors, first data to indicate a speed of the agricultural vehicle, an orientation of a tractive element of the agricultural vehicle, and a position of a crop row relative to the agricultural vehicle;
determine, based on the first data using a nonlinear model, a difference between a heading of the agricultural vehicle and a path to take along the crop row;
generate, responsive to determination of the difference, a prediction of an adjustment to the heading of the agricultural vehicle to align the agricultural vehicle with the path to take along the crop row;
transmit, responsive to generation of the prediction, one or more signals to control the agricultural vehicle to cause the agricultural vehicle to align with the path; and
store, responsive to monitoring movement of the agricultural vehicle, in a database, second data to indicate a plurality of paths taken by the agricultural vehicle along the crop row; and
a second controller comprising one or more second memory devices storing second instructions thereon that, when executed by one or more second processors, cause the one or more second processors to:
retrieve, from the database, at least a portion of the second data; and
generate, based on the at least a portion of the second data, a second path for the agricultural vehicle to take along the crop row at one or more subsequent points in time.

2. The agricultural vehicle of claim 1, wherein the first controller is configured to implement a feedback loop based on the first data, and wherein the second controller is configured to implement a feedforward loop based on the at least a portion of the second data.

3. The agricultural vehicle of claim 1, wherein the first instructions cause the one or more first processors to:
receive, from the one or more sensors, responsive to second movement of the agricultural vehicle subsequent to generation of the second path, third data to indicate a second speed of the agricultural vehicle, a second orientation of the tractive element, and a second position of the crop row relative to the agricultural vehicle; and
update, based on at least a portion of the third data, the second path to adjust third movement of the agricultural vehicle to align the agricultural vehicle with the second path.

4. The agricultural vehicle of claim 1, wherein the first instructions cause the one or more first processors to:
receive, from the one or more sensors, third data to indicate second movement of the agricultural vehicle relative to the crop row;
detect, responsive to a comparison of the at least a portion of the second data and at least a portion of the third data, a deviation from at least one path of the plurality of paths taken by the agricultural vehicle along the crop row; and
transmit, responsive to detection of the deviation, one or more second signals to control third movement of the agricultural vehicle relative to the crop row.

5. The agricultural vehicle of claim 1, wherein:
the first instructions cause the one or more first processors to:
monitor, responsive to transmission of the one or more signals, second movement of the agricultural vehicle to detect the movement of the agricultural vehicle; and
determine, responsive to detection of the movement of the agricultural vehicle, the plurality of paths taken by the agricultural vehicle along the crop row; and
the second instructions cause the one or more second processors to:
generate, based on the plurality of paths and the path, a second prediction of one or more differences between the plurality of paths and the path.

6. The agricultural vehicle of claim 1, wherein the second instructions cause the one or more second processors to:
generate, based on the at least a portion of the second data, a second prediction of a curvature of the crop row;
receive, from the one or more sensors responsive to second movement of the agricultural vehicle, third data to indicate the second movement of the agricultural vehicle; and
generate, based at least one the second prediction and at least a portion of the third data, a third prediction of a change to the curvature of the crop row.

7. The agricultural vehicle of claim 6, wherein the second instructions cause the one or more second processors to:
transmit, responsive to generation of the third prediction, one or more second signals to control the agricultural vehicle to cause the agricultural vehicle to move in accordance with the change to the curvature of the crop row.

8. The agricultural vehicle of claim 6, wherein the second instructions cause the one or more second processors to:
provide, via a prompt on a user interface, a first indication of the third prediction of the change to the curvature of the crop row; and
receive, via an input provided from the user interface, a second indication to control third movement of the agricultural vehicle in accordance with the second prediction of the curvature of the crop row.

9. An agricultural vehicle, comprising:
a controller comprising one or more memory devices storing instructions thereon that, when executed by one or more processors, cause the one or more processors to:
receive, from one or more sensors, first data to indicate a speed of the agricultural vehicle, an orientation of a tractive element of the agricultural vehicle, and a position of a crop row relative to the agricultural vehicle;
determine, based on the first data using a nonlinear model, a difference between a heading of the agricultural vehicle and a path to take along the crop row;
generate, responsive to determination of the difference, a prediction of an adjustment to the heading of the agricultural vehicle to align the agricultural vehicle with the path to take along the crop row;
transmit, responsive to generation of the prediction, one or more signals to control the agricultural vehicle to cause the agricultural vehicle to align with the path; and
store, responsive to monitoring movement of the agricultural vehicle, in a database, second data to indicate a plurality of paths taken by the agricultural vehicle along the crop row;
wherein the controller is configured to implement a feedback loop based on the first data.

10. The agricultural vehicle of claim 9, comprising:
a second controller comprising one or more second memory devices storing second instructions thereon that, when executed by one or more second processors, cause the one or more second processors to:
retrieve, from the database, at least a portion of the second data; and
generate, based on the at least a portion of the second data, a second path for the agricultural vehicle to take along the crop row at one or more subsequent points in time;
wherein the second controller is configured to implement a feedforward loop based on the at least a portion of the second data.

11. The agricultural vehicle of claim 10, wherein the instructions cause the one or more processors to:
receive, from the one or more sensors, responsive to second movement of the agricultural vehicle subsequent to generation of the second path, third data to indicate a second speed of the agricultural vehicle, a second orientation of the tractive element, and a second position of the crop row relative to the agricultural vehicle; and
update, based on at least a portion of the third data, the second path to adjust third movement of the agricultural vehicle to align the agricultural vehicle with the second path.

12. The agricultural vehicle of claim 9, wherein the instructions cause the one or more processors to:
receive, from the one or more sensors, third data to indicate second movement of the agricultural vehicle relative to the crop row;
detect, responsive to a comparison of the at least a portion of the second data and at least a portion of the third data, a deviation from at least one path of the plurality of paths taken by the agricultural vehicle along the crop row; and
transmit, responsive to detection of the deviation, one or more second signals to control third movement of the agricultural vehicle relative to the crop row.

13. The agricultural vehicle of claim 9, comprising:
a second controller comprising one or more second memory devices storing second instructions thereon that, when executed by one or more second processors, cause the one or more second processors to:
generate, based on the at least a portion of the second data, a second prediction of a curvature of the crop row;
receive, from the one or more sensors responsive to second movement of the agricultural vehicle, third data to indicate the second movement of the agricultural vehicle; and
generate, based at least one the second prediction and at least a portion of the third data, a third prediction of a change to the curvature of the crop row.

14. The agricultural vehicle of claim 13, wherein the second instructions cause the one or more second processors to:
transmit, responsive to generation of the third prediction, one or more second signals to control the agricultural vehicle to cause the agricultural vehicle to move in accordance with the change to the curvature of the crop row.

15. The agricultural vehicle of claim 13, wherein the second instructions cause the one or more second processors to:
provide, via a prompt on a user interface, a first indication of the third prediction of the change to the curvature of the crop row; and
receive, via an input provided from the user interface, a second indication to control third movement of the agricultural vehicle in accordance with the second prediction of the curvature of the crop row.

16. A control system for an agricultural vehicle, the control system comprising:
a first controller comprising one or more memory devices storing instructions thereon that, when executed by one or more processors, cause the one or more processors to:
receive, from one or more sensors, first data to indicate a speed of the agricultural vehicle, an orientation of a tractive element of the agricultural vehicle, and a position of a crop row relative to the agricultural vehicle;
determine, based on the first data using a nonlinear model, a difference between a heading of the agricultural vehicle and a path to take along the crop row;
generate, responsive to determination of the difference, a prediction of an adjustment to the heading of the agricultural vehicle to align the agricultural vehicle with the path to take along the crop row;
transmit, responsive to generation of the prediction, one or more signals to control the agricultural vehicle to cause the agricultural vehicle to align with the path; and
store, responsive to monitoring movement of the agricultural vehicle, in a database, second data to indicate a plurality of paths taken by the agricultural vehicle along the crop row; and
a second controller configured to implement a feedforward loop based on at least a portion of the second data.

17. The control system of claim 16, wherein the instructions cause the one or more processors to:
receive, from the one or more sensors, responsive to second movement of the agricultural vehicle subsequent to generation of a second path, third data to indicate a second speed of the agricultural vehicle, a second orientation of the tractive element, and a second position of the crop row relative to the agricultural vehicle; and
update, based on at least a portion of the third data, the second path to adjust third movement of the agricultural vehicle to align the agricultural vehicle with the second path.

18. The control system of claim 16, wherein the instructions cause the one or more processors to:
receive, from the one or more sensors, third data to indicate second movement of the agricultural vehicle relative to the crop row;
detect, responsive to a comparison of the at least a portion of the second data and at least a portion of the third data, a deviation from at least one path of the plurality of paths taken by the agricultural vehicle along the crop row; and
transmit, responsive to detection of the deviation, one or more second signals to control third movement of the agricultural vehicle relative to the crop row.

19. The control system of claim 16, comprising:
the second controller comprising one or more second memory devices storing second instructions thereon that, when executed by one or more second processors, cause the one or more second processors to:
generate, based on the at least a portion of the second data, a second prediction of a curvature of the crop row;
receive, from the one or more sensors responsive to second movement of the agricultural vehicle, third data to indicate the second movement of the agricultural vehicle; and
generate, based at least one the second prediction and at least a portion of the third data, a third prediction of a change to the curvature of the crop row.

20. The control system of claim 19, wherein the second instructions cause the one or more second processors to:
provide, via a prompt on a user interface, a first indication of the third prediction of the change to the curvature of the crop row; and
receive, via an input provided from the user interface, a second indication to control third movement of the agricultural vehicle in accordance with the second prediction of the curvature of the crop row.
